(19) United States
(12) Patent Application Publication
(10) Pub. No.: US 2003/0059745 A1
(43) Pub. Date: Mar. 27, 2003

(54) Device and method for an image demonstration

(76) Inventor: Andrey G. Lukyanov, Moscow (RU)

Correspondence Address: Barry Barrentine, 2 Smith Road, Elkton, MD, 21921, US

(21) Appl. No.: 10/120,638

(22) Filed: Apr. 11, 2002

(30) Foreign Application Priority Data
Apr. 17, 2001 (RU) 2001110236

(51) Int. Cl. G09B 11/00

(52) U.S. Cl. 434/81

(57) ABSTRACT

The Optrix Effect utilizes mathematics in the field of optics to create a three-dimensional movement effect of “sill” images such as faces, products and objects on signs, billboards, light-boxes and many other mediums.

Typical images can be made to “come to life” utilizing the Optrix Effect. The three-dimensional image appears to turn left, right, up or down, depending on the movement of the observer. If the observer stops, the image stops. When the observer moves, the image moves.

Optrix technology can be adapted for use in packaging, advertising, promotions, toys for children, and other applications where increased attention is desired.

The present invention relates to devices and methods of image displaying with special effects.

Conventional displaying devices including conventional two-dimensional demonstrating surface are usually cheap but their demonstrative abilities are limited. Three-dimensional devices being exact replica of displayed image are also well known. A well-known example is an advertisement hoarding with a car protruding from the flat board. These boards make realistic effect but they are expensive and difficult to manufacture. There is a patent EP0968494 WO 98/41969 PCT/GB 97/02816, which describes a device with three-dimensional structure, which has at least one panel that forms recess leading towards an apex. The specific feature of this patent is that only pyramidal objects consisting of several two-dimensional plates can be demonstrated.

The distinctive feature of this particular invention is the ability to demonstrate three-dimensional objects of any forms (cubic, parallelepiped, polyhedral, cylindrical, conic, spherical, and also compound or combined).

This invention represents a device and a method for image displaying. Three-dimensional picture-carrying surface is formed as a representation of the visible part of the surface of the object to be displayed symmetrical with regard to a point, an axis or a plane; the picture of the displayed image is applied on the corresponding reverse side of the symmetrical representation of the displayed object. The borders of the picture coincide with the borders of the carrying surface. Fragments of the displayed image, which are closer to the observer, are situated on the surface further from the observer, and the further image fragments are situated on the carrying surface closer to the observer. Concave fragments of the carrying surface seem to be prominent, while prominent fragments look concave, while the proportions of image on the carrying surface do not change in the expected direction but in the opposite one. Technical result of this invention is an effect of moving, or exactly of turning and sometimes effect of transformation of the image produced when the observer changes the angle of view in respect of the picture-carrying surface.

A three-dimensional object of any shape (polyhedral, cylindrical, spherical, and also compound and combined and etc.) can serve as displayed object. The visible demonstrated part of the surface of the object can be of any form and include fragments of any shape. The visible surface of a displayed object may be convex, concave, combined and include flat fragments. A three-dimensional displayed object may consist of three-dimensional fragments, include flat fragments or consists of flat fragments.

The visible (demonstrated) surface of the displayed object forms the demonstration surface, which represents the device. The surface is formed as representation of the demonstrated surface of the displayed object, symmetrical in respect of a point, an axis or a plane. The borders of the visible surface of the displayed object coincide with the borders of the demonstrating surface serving as the displaying device. The carrying surface, forming the device, is made as representation of the visible surface of the displayed object symmetrical in respect of a point, an axis or a plane without changing proportions and relief or with partial or full changing of proportions or/and relief.

The picture on the carrying surface contains a three-dimensional image consisting of one or several three-dimensional objects; an image consisting of two-dimensional objects of any form and three-dimensional objects of any form in any combination or an image consisting of two-dimensional objects of any form. The image can be applied on the carrying surface by any existing method, for example by printing, painting, engraving; it can be put on the carrying surface together with a layer of a material containing image. In case of any partial or complete irregularity of the surface relief, the picture may contain an image with relief corresponding to the irregular fragments of the visible surface relief of the displayed object. Although it is preferable that the relief of the visible surface of the displayed object and the relief of the demonstrating surface coincide, however the relief of the image contained in the picture can differ from the relief of the demonstrating surface producing additional visual effects. It is possible not to apply the picture at all but to form it by relief and distribution of light on it.

The carrying surface is made observing the well known rules of linear perspective (in this case the realistic effect of turning would be achieved) or with the breach of these rules in all or several surface fragments (in this case there would be an effect of turning and transformation of all or several fragments of the image).

The three-dimensional carrying surface can be made of an entire piece of material, or from several objects or several pieces of material. The carrying surface can be made applying different methods: extrusion, compressing, moulding, milling, welding and any other known methods. The three-dimensional carrying surface can be as thin as possible, for example, 1 micrometer and up to ten metres or more. It can be made from wood, paper, plastic, metal, plaster, polymer, plywood, stone, glass, fabric, luminous materials or any others existing in nature materials.

The three-dimensional picture-carrying surface of the displaying device may be attached to a pole, to three-dimensional or two-dimensional supporting construction, or hung up or just mounted. If the three-dimensional carrying surface is attached to a three-dimensional or flat supporting construction, it can be attached without intrusion into the construction or it can partially be in a cut formed in flat or three-dimensional supporting structures so that the carrying surface intrude at least partially into the cut. The cut is made accordingly to the section perimeter of the carrying surface, which intrudes into the supporting device, and formed by the curvilinear or flat surface of the supporting structure.

Three-dimensional picture-carrying surface of the device may fully intrude into the cut in the supporting structure, for example in the mass of material. In this case the border of the three-dimensional carrying surface of the device and that of the supporting structure, in which the carrying device intrudes, may be even two-dimensional or uneven two-dimensional and three-dimensional.

Here the illustration of one of many possibilities of using this invention:

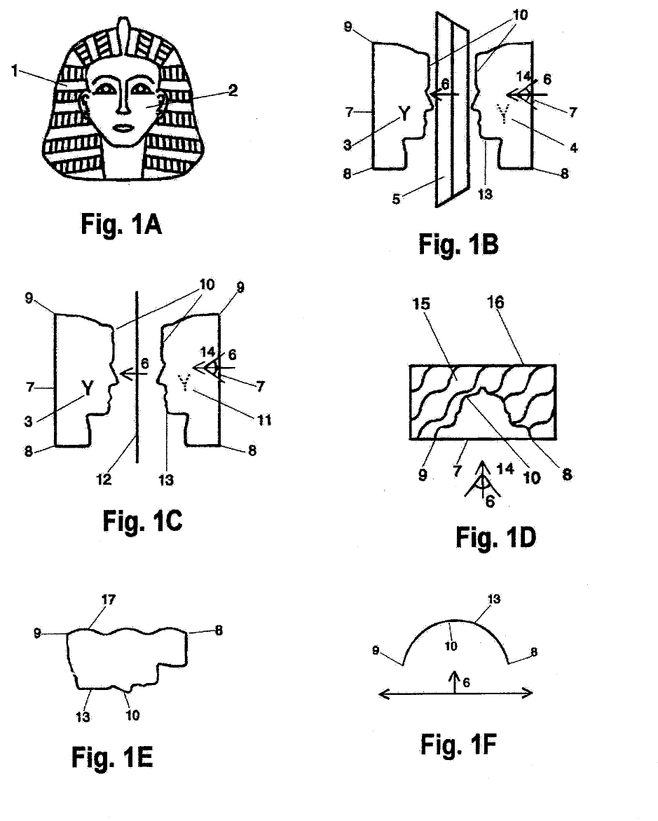

The effect of movement is produced by a three-dimensional carrying surface made by representation of the surface symmetrical in respect of a point, an axis or a plane where the displayed object is a three-dimensional head of Tutanhamon cut along the border of the visible part of the object displayed in full face. On the FIG. 1A there is a picture of the displayed object—three-dimensional, mostly convex with multi-fragmental convexo-concave relief. Number 1 indicates the perimeter—the border of the visible part of the displayed object, number 2 indicates the picture of the displayed object, which coincide with the relief of the carrying surface.

The FIG. 1B (the side view) represents a three-dimensional displayed object (number 3). Number 4 is the symmetrical representation of the surface in respect of a plane; number 5—the plane of symmetry; number 6—the direction of the glance of an observer that corresponds to the angle of looking at the displayed image as shown on the FIG. 1A. Number 7 is the border of section of the visible part of the displayed object (image), which is also the section perimeter line of the carrying surface, made by the curvilinear or flat surface of the supporting structure from point 8 to point 9. It can be seen that the section is flat. Number 10 is the side, containing the picture, from point 8 to 9, which corresponds to the visible part of the object surface and to the carrying surface of the device. Points 8 and 9 are the extreme points of the section of the visible part. Letter v indicates the left side of the displayed object, The dotted letter v indicates the left side of the symmetrical image. You can see that the picture of the displayed object is formed on the reverse side of the representation, symmetrical in respect of the plane, of the visible surface of the displayed object. The left and the right sides of the displayed object would coincide with the left and the right representation of image when looking from the point 6.

The representation, symmetrical in respect of an axis (11), of the displayed object (12) is shown on the FIG. 1C. In this case the left and the right sides of the displayed object will change their places. On the symmetrical representation the representation of the relief would not be mirror representation, but the image on the reverse side (from the point 6) would be mirror representation.

The same mirror image as on the FIG. 1B would be on the reverse side of the representation symmetrical in respect of a point. All the symmetrical representations can be used for displaying image but a representation symmetrical in respect of a plane is more promising.

The carrying surface of the device is indicated by number 13 (from point 8 to 9) on FIGS. 1B and 1C. Its borders coincide with the borders of the displayed object picture—2 (FIG. 1A) taken as the basis for forming a picture along the perimeter of the border of the visible part (FIGS. 1B and 1C, number 7).

The surface of a three-dimensional displayed object with an applied picture (number 2, FIG. 1A) corresponds to the historical image of Tutanhamon without changes in proportions. The relief of the surface of the three-dimensional displayed object with a picture, which were taken as the basis for forming the demonstrating surface and the image on it (FIGS. 1b, 1C, 1D), is preserved on the displayed image.

The angle from which one can best see the moving effect when the observer is moving vertically, is shown by number 14, FIGS. 1B, 1C. The angle from which one can best see the moving effect if the observer moves horizontally is shown on FIG. 1D. If the observer moves diagonally the moving effect still takes place.

The mostly convex relief of the displayed object turns to a mostly concave relief on the carrying surface. Small elements of relief also change; those that were concave become convex; convex elements become concave.

FIG. 1D—view from above—shows one of examples when the carrying surface with a picture is made from an entire piece of material (number 15), arbitrary form of material (number 16), where the perimeter of the visible part is the border of the material bulk. The thickness is not limited; it can reach 10 metres or more. Minimum thickness of the carrying surfaces (number 13, FIGS. 1B, 1C) can be as little as possible and depends on the kind of material, so that the construction would be strong enough, in some occasions it can be of 1 micrometer. The entire piece of material used as a supporting structure of the carrying surface can have a three-dimensional shape of any existing object. The border of the carrying surface (number 1) is represented by a curved line in a two-dimensional plane.

FIG. 1E shows that the border of the carrying surface coincides with the border of the visible part of the object; the border is three-dimensional and represented by a closed curved line.

The border of the carrying surface, which coincides with the border of the visible part of the object, is made here so as to ensure that the edges don't hide the main inside image. It's admissible that the border hides more than 50% of the image. In that case moving effect would still appear, and the inside part of the concave carrying surface would be partly seen by observer. The demonstration angle of the moving effect should be in the limits of 15 degrees for very concave surfaces up to 170 degrees for slightly concave surfaces.

The ratio of the area of the possibly largest section of the three-dimensional carrying surface to the area of the internal carrying surface varies from 1:1 to 1:10.

The largest possible section of the carrying three-dimensional surface can have an angle of inclination in respect of the floor from 5 degrees to 90 degrees.

You can see on FIG. 1D that the three-dimensional concave display surface with a face has a form close to the form of a circle segment in horizontal section (although it doesn't coincide with it). In this case the relief of the carrying surface is close to the spherical form. It coincides with the relief of the displayed object (in our case it is a face).

FIG. 1F shows that the three-dimensional concave display surface with the picture of a face, in horizontal section has the form of a circle segment; in this case the relief of the carrying surface has the form of a cylinder fragment and does not coincide with the relief of the displayed object.

To demonstrate movement of a three-dimensional object you can use a three-dimensional plate in the form close to the one of a cylinder fragment with a two-dimensional angle, which can be 30 degrees larger or smaller than a two-dimensional angle that could circumscribe the object.

Partial or full flattening of the display surface relief in comparison with the displayed object as well as application of an image with relief corresponding to the displayed object on a flatter surface is not only possible but profitable.

When a picture with a two-dimensional or three-dimensional object is applied on the surface that has a form close to a fragment of a cylinder or of a sphere, the display surface borders coincide with the borders of the picture, and the fragments of the surface which do not contain any picture are considered to be the supporting structure.

The same procedures that are used for creation of dynamic effect for a three-dimensional convex displayed object can be used for concave objects. The difference is that “convex” replaces “concave”.

The other potential usage of the invention:

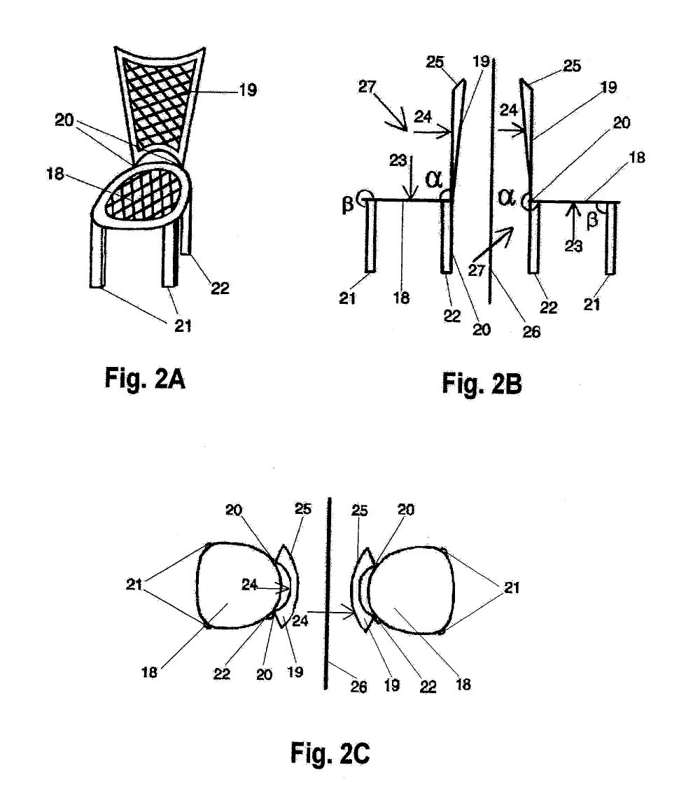

FIG. 2A shows a chair as a three-dimensional displayed object. The seat and back appear to be concave in respect of the front legs. The flat seat is indicated by number 18; number 19 is a three-dimensional back made as a truncated cone fragment, 20 is attachment points of back and seat, 21—the front legs, 22—a back distant leg.

FIG. 2B shows the same object from side view, and the representation of the object, made in respect of an axis. Number 18 indicates a flat seat; 19 is a three-dimensional back, made as a truncated cone fragment; 20—attachment points of the back and the seat; 21—the front legs; 22—a back distant leg; 23—the demonstrated surface of the seat, containing a picture; and 24—the demonstrated surface of the back with a picture; 25 shows the curve of the upper edge of the back; 26—the plane of symmetry, in respect of which the symmetrical representation is formed; 27—the optimum direction for an observer to look, α—a dihedral (two-sided) angle between the back and the seat, in our case it equals 90 degrees, β—a dihedral angle between the seat and the plane, on which the legs are situated, and it equals in our case 90 degrees.

The image applies on the reverse side of the representation, and because of this the optimum direction of viewing (27) changes on 180 degrees in respect of the α angle. As result of this the part of the object, which looked convex, (the sides of the angle β) becomes concave (the sides of an angle of 360 degrees minus β), and the part of the object, which looked concave (the sides of the angle α) becomes convex (the sides of an angle 360 degrees minus α).

The carrying surface with the picture in this case is made from thin elements, which have the same shape as the displayed object elements.

A three-dimensional displayed object, taken as the basis for forming the carrying surface and a picture, has two flat plates attached to each other. The pictures applied on corresponding surfaces are three-dimensional and volumetric.

### FORMULA OF INVENTION

Paragraph 1. A device and a method for displaying of an image that includes a three-dimensional surface with an applied picture, with the following specific features:

a three-dimensional carrying surface formed as a symmetrical representation of the displayed object surface;

the picture of the displayed object is applied on the reverse side of the symmetrical representation of the displayed object so as to ensure that there is a visual effect of turning (and, in some cases, transformation) of the image when the observer changes the angle of observance.

Paragraph 2. The device described in §1 wherein the three-dimensional carrying surface is formed as representation of the displayed object surface symmetrical in respect of a point.

Paragraph 3. The device described in §§1-2 wherein the picture of the displayed object is applied on the side corresponding to the reverse side of the symmetrical representation of the displayed object.

Paragraph 4. The device described in §§1-3 wherein the displayed object, which is taken as the basis for forming a picture applied on the carrying surface of the device is three-dimensional.

Paragraph 5. The device described in §§1-4 wherein a three-dimensional displayed object, taken as the basis for forming a picture, has a border of the visible surface, which is taken as the basis for forming the carrying picture surface and the device itself.

Paragraph 6. The device described in §§1-5 wherein the border of the visible surface of the displayed object coincides with the borders of the image-displaying device.

Paragraph 7. The device described in §§1-6 wherein the displayed image fragments, which are closer to the observer, are situated further from him on the carrying surface, and the further fragments are situated closer to him on the carrying surface. Concave fragments of carrying surface look convex, and the convex ones look concave. When the observer is moving, proportion of the image on the carrying surface change in the direction opposite to the expected one.

Paragraph 8. The device described in §§1-7 wherein the visible surface of a three-dimensional displayed object taken as the basis for forming the image-carrying surface can be of any form: polyhedral, cylindrical, spherical, and combined or compound.

Paragraph 9. The device described in §§1-8 wherein the visible surface of a three-dimensional displayed object taken as the basis for forming the carrying surface is convex.

Paragraph 10. The device described in §§1-9 wherein the visible surface of a three-dimensional displayed object taken as the basis for forming the carrying surface is concave.

Paragraph 11. The device described in §§1-10 wherein the visible surface of a three-dimensional displayed object taken as the basis for forming the carrying surface may have convex and concave fragments.

Paragraph 12. The device described in §§1-11 wherein the visible surface of a three-dimensional displayed object taken as the basis for forming the carrying surface may consist of flat fragments or have flat fragments in any combination as it was described in §§1-9.

Paragraph 13. The device described in §§1-12 wherein the image-carrying surface, which forms the device, is made as a representation of the visible surface of the displayed object symmetrical in respect of a point, an axis or a plane without changes in proportions.

Paragraph 14. The device described in §§1-13 wherein the image-carrying surface, which forms the device, is made as a representation of the visible surface of the displayed object symmetrical in respect of a point, an axis or a plane with changes in proportions of every fragment of the surface.

Paragraph 15. The device described in §§1-14 wherein the image-carrying surface, which forms the device, is made as a representation of the visible surface of the displayed object symmetrical in respect of a point, an axis or a plane with partial changes in proportions.

Paragraph 16. The device described in §§1-15 wherein the image-carrying surface, which forms the device, is made as a representation of the visible surface of the displayed object symmetrical in respect of a point, an axis or a plane without changes in relief.

Paragraph 17. The device described in §§1-16 wherein the image-carrying surface, which forms the device, is made as a representation of the visible surface of the displayed object symmetrical in respect of a point, an axis or a plane with changes of relief in every fragment of the surface

Paragraph 18. The device described in §§1-17 wherein the image-carrying surface, which forms the device, is made as a representation of the visible surface of the displayed object symmetrical in respect of a point, an axis or a plane with partial changes in relief.

Paragraph 19. The device described in §§1-18 wherein the image on the carrying surface, which forms the device, may contain an image consisting of three-dimensional objects.

Paragraph 20. The device described in §§1-19 wherein the image on the carrying surface, which forms the device, may contain an image consisting of three-dimensional and flat objects.

Paragraph 21. The device described in §§1-20 wherein the image on the carrying surface, which forms the device, may contain an image consisting of several flat objects.

Paragraph 22. The device described in §§1-18, 19-20 wherein three-dimensional objects forming an image, situated on the image on the carrying surface, may be of any form: cube, parallelepiped, polyhedral, conic, spherical, and compound or combined.

Paragraph 23. The device described in §§1-18, 20-21 wherein two-dimensional objects forming the image, situated on the image on the carrying surface, may be of any form: square, parallelogram, polygonal, triangle, ellipsoid, and compound or combined.

Paragraph 24. The device described in §§1-23 wherein the image on the carrying surface, which forms the device, may be applied using different methods, including printing, painting, engraving and any other existing methods.

Paragraph 25. The device described in §§1-23 wherein the image can be applied on the carrying surface, which forms the device, together with a layer of material that contains the picture.

Paragraph 26. The device described in §§1-25 wherein the image on the carrying surface, which forms the device, is made as symmetrical representation of the visible surface of the object with changes in relief of all fragments of the device, and contains a three-dimensional image with relief corresponding to the displayed object relief.

Paragraph 27. The device described in §§1-26 wherein the image on the carrying surface, which forms the device, is made as symmetrical representation of the visible surface of the object with changes in relief of several fragments of the device, and contains a three-dimensional image with relief corresponding to the displayed object relief.

Paragraph 28. The device described in §§1-27 wherein the image may not be applied the carrying surface, which forms the device but be formed by this surface relief and by distribution of light on it.

Paragraph 29. The device described in §§1-28 wherein the image on the carrying surface, which forms the device, is made as a representation of the visible surface of the displayed object, symmetrical in respect of a point, an axis or a plane following the rules of linear perspective in all fragments of the surface. In this case the realistic effect of turning the image will be achieved.

Paragraph 30. The device described in §§1-29 wherein the image on the carrying surface, which forms the device, is made as a representation of the visible surface of the displayed object, symmetrical in respect of a point, an axis or a plane, with breaching the rules of linear perspective in some fragments of the surface. In this case an effect of turning the image and of partial image transformation will be achieved.

Paragraph 31. The device described in §§1-29 wherein the image on the carrying surface, which forms the device, is made as a representation of the visible surface of the displayed object, symmetrical in respect of a point, an axis or a plane, with breaching the rules of linear perspective in all fragments of the surface. In this case an effect of turning the image and of image transformation in all its fragments will be achieved.

Paragraph 32. The device described in §§1-31 wherein the three-dimensional carrying surface is made of an entire piece of material.

Paragraph 33. The device described in §§1-31 wherein the three-dimensional carrying surface is made of several objects or pieces of material.

Paragraph 34. The device described in §§32-33 wherein the three-dimensional carrying surface is made using extrusion, compressing, casting, milling, welding and any other existing methods.

Paragraph 35. The device described in §§1-34 wherein the three-dimensional carrying surface is as thin as possible, for instance, beginning from 1 micrometre up to 10 metres and more.

Paragraph 36. The device described in §§1-35 wherein the three-dimensional carrying surface is made of wood, paper, plastic, metal, plaster, polymers, plywood, stone, glass, fabric, luminous materials or any others existing in nature materials.

Paragraph 37. The device described in §§1-36 wherein the three-dimensional carrying surface is situated under any visual angle of a moving observer from 10 to 170 degrees.

Paragraph 38. The device described in §§1-37 wherein the three-dimensional image-carrying surface, which forms the displaying device, is attached to a pole, a supporting structure, or hanged or just mounted.

Paragraph 39. The device described in §§1-38 wherein the three-dimensional image-carrying surface, which forms the displaying device, may be attached to a flat or three-dimensional supporting structure.

Paragraph 40. The device described in §§1-39 wherein the three-dimensional image-carrying surface, which forms the displaying device, may be situated at least partially in a cut formed in a flat or three-dimensional structure so that the carrying surface enter at least partially into the cut.

Paragraph 41. The device described in §§1-40 wherein the shape of the cut made correspondingly to the shape of the perimeter, which is formed along the perimeter of the section of the carrying surface, which enters into the supporting structure, by curvilinear or flat surface of the supporting structure.

Paragraph 42. The device described in §§1-40 wherein the three-dimensional image-carrying surface, formed as provided in §§18-27, may be entirely situated in a hollow of the three-dimensional supporting structure, for example, in the mass of material.

Paragraph 43. The device described in §§1-42 wherein the border of the three-dimensional carrying surface, which forms the device and of the supporting structure, in a hollow of which the device is situated, is two-dimensional.

Paragraph 44. The device described in §§1-40 wherein wherein the border of the three-dimensional carrying surface, which forms the device, and of the supporting structure, in the hollow of which is situated the device, is three-dimensional.

Paragraph 45 The device described in §§1-46 may be lightened from the front side or from the back side. In the latter case the device should be at least partly made of transparent materials.

Paragraph 46. The described above device for displaying an image is given with references to illustrations.

### SUMMARY

A device and a method for displaying an image comprising three-dimensional carrying surface, on which a picture is applied, have the following specific features:

the three-dimensional carrying surface is formed as a symmetrical representation of the displayed object surface.

the picture of the displayed object is applied on the reverse side of the symmetrical representation of the displayed object surface.

This device allows demonstration of images of any form: convex, concave, convexo-concave, cylindrical, polyhedral, conic, and also images of combined and curvilinear form. This device can be used in advertisement hoardings, shop windows, indoors as a design element, in production of souvenirs and consumer goods, interior decoration, and everywhere when there is a need of demonstration.

1. I claim to have discovered a new graphics technology based on the science of optics, illusion and special effects. It is well known that “eyes” on an image can appear to follow you. By using the new Optrix effect on a billboard, sign or display, whole advertised items (cans, bottles, boxes, faces or images, etc.) can appear to dramatically move.
Images and signs literally come to life—significantly increasing the promotional value and impact of a product. By using the Optrix technology, images appear to turn up, down, left or right depending on the movement of the observer. If the observer stops, the image stops, when the observer moves the product or image moves.
It's projected uses include billboards, signs, point of purchase displays, posters, packaging and sculptures.
